(19) United States
(12) Patent Application Publication
(10) Pub. No.: US 2015/0309838 A1
(43) Pub. Date: Oct. 29, 2015

(54) REDUCTION OF PROCESSING DUPLICATES OF QUEUED REQUESTS

(71) Applicant: International Business Machines Corporation, Armonk, NY (US)

(72) Inventor: Gabrielle Z. Steele, Lockerley (GB)

(21) Appl. No.: 14/670,948

(22) Filed: Mar. 27, 2015

(30) Foreign Application Priority Data
Apr. 29, 2014 (GB) 1407478.5

(51) Int. Cl. G06F 9/48

(52) U.S. Cl. CPC G06F 9/48

(57) ABSTRACT

Aspects of the present invention disclose a method, computer program product, and system for managing queued requests. The method includes one or more processors accessing a queue that includes a plurality of read requests. The method further includes one or more processors identifying read requests in the plurality of read requests that are identical. The method further includes one or more processors determining whether grouping the identical read requests is an efficient use of one or more resources. In an additional aspect, the method further includes responsive to determining that grouping the identical read requests is an efficient use of one or more resources, one or more processors grouping the identical read requests together for processing as a single request.

### BACKGROUND OF THE INVENTION

The present invention relates generally to the field of processing of queued requests, and more particularly to processing duplicates of queued requests.

In many software systems, requests are queued to be handled individually when a request processing thread becomes available. For example, if several people were trying to generate the same report on a single-threaded system (or a system with limited processing threads in a pool), they would produce the same report, but processing would be required for each (assuming nothing was written to the data store between requests).

A solution is to use a server-side cache for the results. However, there are situations when a cache is not possible. Such situations could be in small-memory footprint applications, such as small, low-powered devices or in memory-constrained systems. In other situations, there may be a library of large documents that many people access concurrently. A cache may only be able to hold a few documents at once, while the requests may be for more documents than the cache can hold.

### SUMMARY

Aspects of the present invention disclose a method, computer program product, and system for managing queued requests. The method includes one or more processors accessing a queue that includes a plurality of read requests. The method further includes one or more processors identifying read requests in the plurality of read requests that are identical. The method further includes one or more processors determining whether grouping the identical read requests is an efficient use of one or more resources. In an additional aspect, the method further includes responsive to determining that grouping the identical read requests is an efficient use of one or more resources, one or more processors grouping the identical read requests together for processing as a single request.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a flow diagram of an example embodiment of an aspect of a method, in accordance with the present invention;

FIG. 2 is a flow diagram of an example embodiment of an aspect of a method, in accordance with the present invention;

FIG. 3 is a flow diagram of an example embodiment of an aspect of a method, in accordance with the present invention;

FIG. 4 is block diagram of an example embodiment of a system, in accordance with the present invention; and

FIG. 5 is a block diagram of an embodiment of a computer system in which the present invention may be implemented.

### DETAILED DESCRIPTION

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numbers may be repeated among the Figures to indicate corresponding or analogous features.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are provided for grouping identical read requests, performing a read, and returning the same response to all requestors of the identical read requests.

The method and system programmatically analyze queued requests to identify and group identical read requests. Identical read requests are grouped, which can reduce processing duplicates of queued requests whilst taking into account modification (if any) of resources or data sources taking place between any two identical read requests.

Programmatic analysis of a queue of requests may be used to identify identical read requests that would lead to identical responses. The complexity of this analysis is dependent on the complexity of the requests themselves. However, a simple example can clearly show the benefit of preventing duplicate request processing:

Queue:
a) Find all files ending “.file”
b) Find all files ending “.file”
c) Find all files ending “file”

In the case of requests a) and b), the requests are clearly the same request and will yield the same response (with an exception of if an intervening write request occurs, which is discussed below). The system can return the response for request a) to request b) also, but without the need of repeating the processing required to form the response.

Further analysis of the example queue reveals that response to requests a) and b) is a subset of the response to request c), since anything ending “.file” would match for “*file.” Therefore, the system can determine that the most efficient way to process the requests would be to process request c), and then when processing requests a) and b) together search only within the result of request c).

Various embodiments of the present invention determine whether to use request grouping at runtime. Grouping requests may not always be the most efficient use of resources, since request grouping may take more resource to analyze the queue than it saves. For example, if the requests are very quick to process, then it is possible to determine at runtime if the system should be using request grouping or not, so long as some averages are known.

In this example, time taken without request grouping can be represented as, x=average response time per request*number of requests, and time taken with request grouping can be represented as, y=average queue processing time per request*number of requests. If x>y, then it is probable that grouping requests can save time. This example can be simplified to “if [average response time per request>average queue processing time per request].”

Different systems may be interested in saving different resources. For example, if memory is the main issue rather than time, then the time averages may be replaced with memory usage averages. Other relevant resources that might be handled in a corresponding manner can be immediately apparent to one of ordinary skill in the art. For example, other relevant resources can include, but are not limited to: processing usage, network usage, disk usage, database usage.

Various embodiments of the present invention can utilize potential effects of write requests. Grouping of requests may take into account whether any resource or data source will be modified between the requests. If this is the case, the requests cannot be grouped, as it would affect the result given.

For example, case 1:
a) Read i
b) Read i
c) Write i

In case 1 above, requests a) and b) can be grouped, because the write request c) occurs after requests a) and b).

For example, case 2:
a) Read i
b) Write i
c) Read i

In case 2, requests a) and c) cannot be grouped, since the request b) may alter “i” in a way that a) and c) get different responses.

According to an aspect of the present invention, a) is provided for method reduction of processing duplicates of queued requests, comprising: accessing a queue of requests, wherein the requests include multiple read requests; determining at runtime if grouping requests is efficient for one or more selected resources; if it is determined to be efficient to group requests, then grouping requests by: grouping together two or more identical read requests for processing as a single request; and determining if there are any intervening write requests between grouped read requests and, if so, ungrouping the one or more read requests after the intervening write request.

The process of grouping requests may include: determining if there are any later more general read requests and, if so, grouping the identical read requests after the more general read requests. A more general read request may return a response, which is a superset of a less general read request.

The process of determining at runtime if grouping requests is efficient for one or more selected resources, may include: selecting a resource; determining an average request response usage of the resource; determining an average queue grouping processing usage of the response per request; if the average request response usage of the resource is greater than the average queue grouping processing usage of the resource per request, then grouping requests is efficient for the selected resource. A resource may be one of the group of: time, memory usage, processing usage, network usage, disk usage, database usage, or other relevant resource that might be handled in the same way and which is immediately apparent to one of ordinary skill in the art.

According to another aspect of the present invention, a system is provided for reduction of processing duplicates of queued requests, comprising: a request processing analyzer for accessing a queue of requests, wherein the requests include multiple read requests; a grouping decision component for determining at runtime if grouping requests is efficient for one or more selected resources; and a grouping component, wherein if it is determined to be efficient to group requests, then the grouping component is operated, the grouping component including: an identical read component for grouping together two or more identical read requests for processing as a single request; and an intervening write component for determining if there are any intervening write requests between grouped read requests and, if so, ungrouping the one or more read requests after the intervening write request.

The grouping component may include: a more general read component for determining if there are any later more general read requests and, if so, grouping the identical read requests after the more general read requests. A more general read request may return a response, which is a superset of a less general read request.

The grouping decision component may include: a resource selection component for selecting a resource; an average resource usage determining component for determining an average request response usage of the resource, and determining an average queue grouping processing usage of the response per request; a decision component for deciding, if the average request response usage of the resource is greater than the average queue grouping processing usage of the resource per request, then grouping requests is efficient for the selected resource. A resource may be one of the group of: time, memory usage, processing usage, network usage, disk usage, database usage, or other relevant resource that might be handled in the same way and which is apparent to one of ordinary skill in the art.

According to another aspect of the present invention, a computer program product is provided for reduction of processing duplicates of queued requests, the computer program product comprising a computer-readable storage medium having computer-readable program code embodied therewith, the computer-readable program code configured to: access a queue of requests, wherein the requests include multiple read requests; determine at runtime if grouping requests is efficient for one or more selected resources; if it is determined to be efficient to group requests, then grouping requests by: grouping together two or more identical read requests for processing as a single request; and determining if there are any intervening write requests between grouped read requests and, if so, ungrouping the one or more read requests after the intervening write request.

The described aspects of the invention can provide the advantage of preventing processing duplicates of queued requests in systems in which it is not possible to have a cache or it is only possible for the cache to hold a few documents at once.

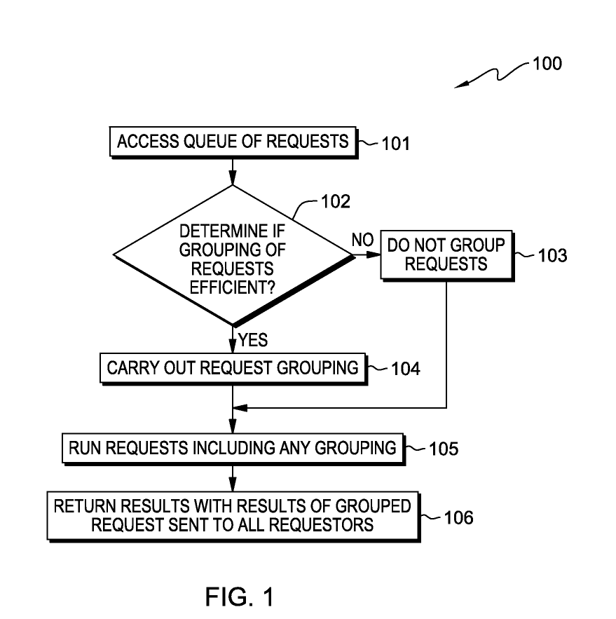

Referring to FIG. 1, flow diagram 100 depicts an embodiment of the described method. In process 101, a queue of requests is accessed for potential grouping of identical read requests.

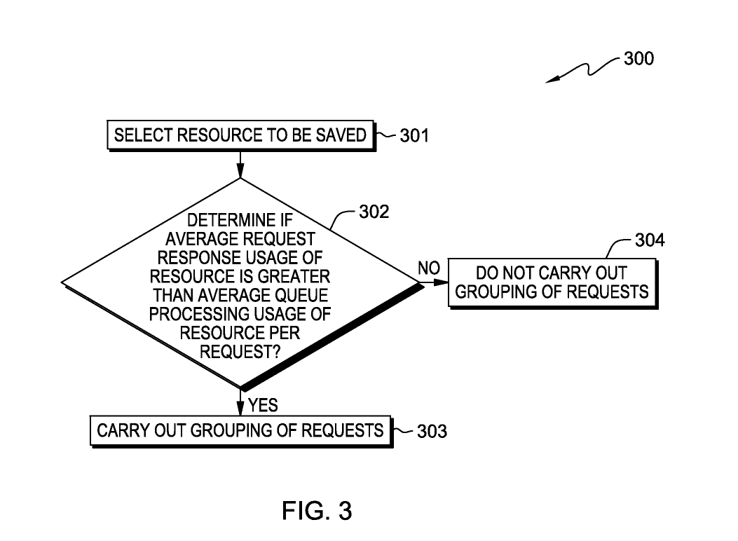

In decision process 102, flow diagram 100 determines whether grouping of identical read requests is efficient for the system. The determination may be based on a selected resource and is described further in relation to FIG. 3. If grouping identical read requests is efficient for the system to carry out (decision process 102, yes branch), then request grouping is carried out for the queue (process 104). However, if grouping identical read requests is not determined to be efficient for the system (decision process 102, no branch), then no grouping is carried out (process 103).

In process 105, the queued requests, including any groupings of identical read requests, may be run. Then, the results of the requests are returned (process 106). The results of grouped requests are returned to all the requestors of the individual requests within the group.

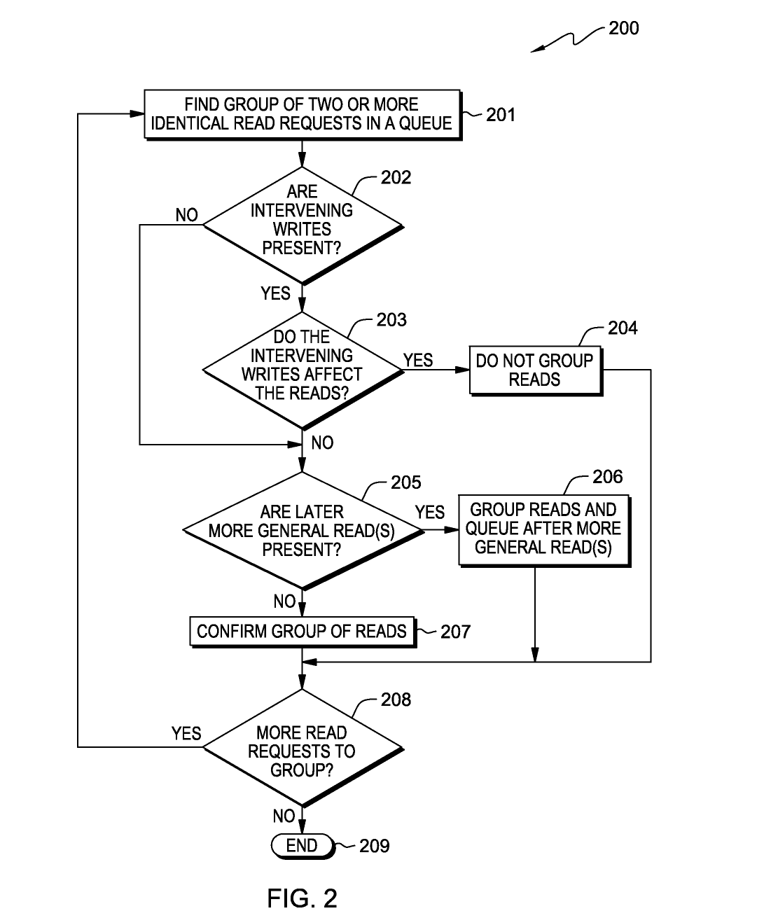

Referring to FIG. 2, flow diagram 200 depicts an example embodiment of a method for grouping requests, in accordance with embodiments of the present invention.

In process 201, a group of two or more identical read requests are found in an accessed queue of requests. In decision process 202, flow diagram 200 determines whether any intervening writes are present within the group of read requests. If any intervening writes are present within the group of read requests (process 202, yes branch), then process 203 determines whether the intervening writes affect the read requests in the group (e.g., separate the read requests). If one or more intervening writes affect the read requests in the group (decision process 203, yes branch), then process 204 does not group the read requests, and flow diagram 200 proceeds to process 208 to determine whether more read requests exist to group.

If no intervening writes are present (decision process 202, no branch), then process 205 determines whether any more general read requests exist in the queue after the grouped read requests. In addition, if intervening writes are present, but the intervening writes do not affect the grouped read requests (decision process 203, no branch), then process 205 determines whether any more general read requests exist in the queue after the grouped read requests.

If more general read requests exist in the queue after the grouped read requests (decision process 205, yes branch), then process 206 groups the read requests and queues the read requests after the more general read request(s). If no more general read requests exist after the grouped read requests (decision process 205, no branch), then process 207 confirms the group of read requests.

Decision process 208 determines whether more read requests are available to group. If more read requests are available to group (decision process 208, yes branch), flow diagram 200 loops to process 201 and finds another two or more identical read requests in the queue. If no more read requests are available to group (decision process 208, no branch), flow diagram 200 ends (process 209).

Referring to FIG. 3, flow diagram 300 depicts an example embodiment of determining if grouping read requests is efficient, in accordance with embodiments of the present invention.

In a system, a resource is selected as being required to be saved or maximized (process 301). The system may require more resource use to analyze a queue than is saved on processing by grouping read requests. For example, a resource may be time taken, memory used, processing power used, network usage, disk usage, database usage, or any other relevant resource that might be measured.

Decision process 302 determines whether the average request response usage of a resource is greater than the average queue processing usage of the resource per request. If the response usage is greater (decision process 302, yes branch), then process 303 carries out the grouping of requests. However, if the queue processing usage is greater (decision process 302, no branch), then process 304 does not carry out the grouping of requests.

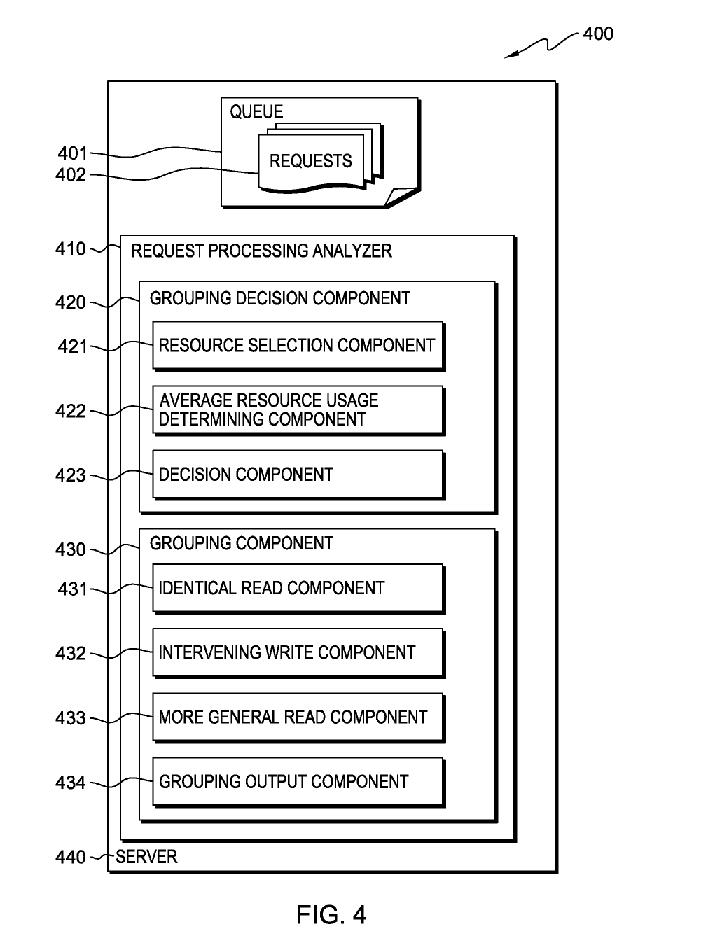

Referring to FIG. 4, a block diagram depicts an embodiment of system 400, which is provided at server 440, in accordance with embodiments of the present invention.

Server 440 includes queue 401, which includes a plurality of requests 402 that may include read requests and write requests. Server 440 includes request processing analyzer 410, which includes grouping component 430 and, optionally, grouping decision component 420. Grouping component 430 groups requests in the queue for processing. Grouping decision component 420 determines whether selected resources will be efficient for processing the grouping of requests.

Grouping decision component 420 may include resource selection component 421 for selecting a resource against which the processing efficiency is determined. Additionally, grouping decision component 420 can select more than one resource. For example, the resource may be processing time, memory usage, processing capacity used, etc.

In addition, grouping decision component 420 may include average resource usage determining component 422 for determining the average amount of resource usage per request for obtaining a request response and the average amount of resource usage per request for processing the requests to group the requests. Further, grouping decision component 420 can provide decision component 423, for comparing average amounts of resource usage. For example, if the average is higher for obtaining a request response, then decision component 423 can determine to carry out grouping.

Grouping component 430 may include identical read component 431 for finding identical read requests for grouping as a single read request. In addition, grouping component 430 can include intervening write component 432, which determines if any intervening writes exist between grouped read requests that would affect the read requests. For example, if intervening write component 432 determines that intervening writes exist that would affect the reads, then the grouping may not be appropriate.

Grouping component 430 includes more general read component 433, which can determine if more general read requests occur after a group of read requests. If more general read requests are occurring, then more general read component 433 can queue the grouped read requests after the more general read request, which allows the results to be narrowed before carrying out the group request. Grouping component 430 includes grouping output component 434, which provides output of the grouped requests and amends the queued requests accordingly.

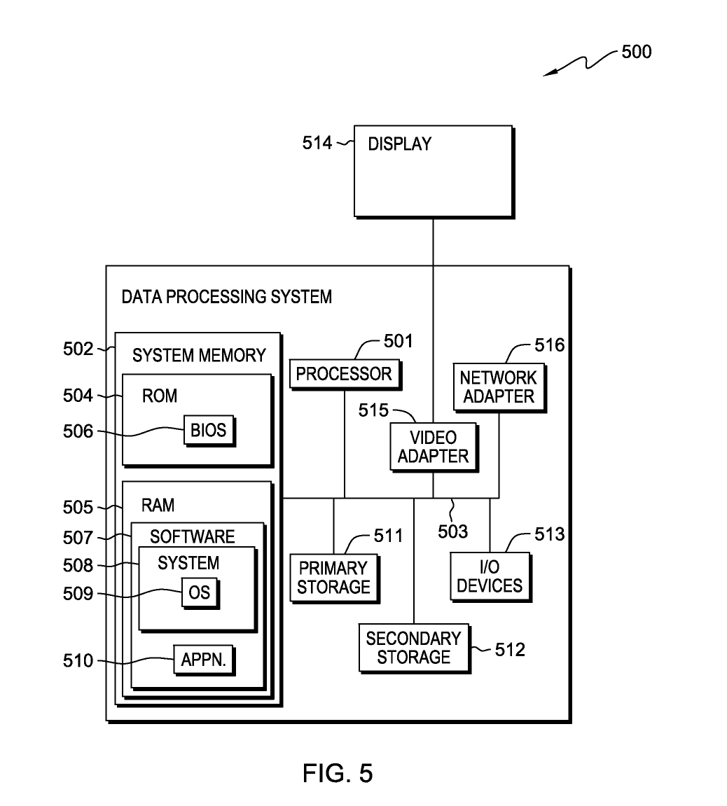

Referring to FIG. 5, an exemplary system for implementing aspects of the invention includes a data processing system 500 suitable for storing and/or executing program code including at least one processor 501 coupled directly or indirectly to memory elements through a bus system 503. The memory elements may include local memory employed during actual execution of the program code, bulk storage, and cache memories which provide temporary storage of at least some program code in order to reduce the number of times code must be retrieved from bulk storage during execution.

The memory elements may include system memory 502 in the form of read only memory (ROM) 504 and random access memory (RAM) 505. A basic input/output system (BIOS) 506 may be stored in ROM 504. Software 507 may be stored in RAM 505 including system software 508, itself including operating system software 509. Software applications 510 may also be stored in RAM 505.

The system 500 may also include a primary storage means 511, such as a magnetic hard disk drive and secondary storage means 512, such as a magnetic disc drive and an optical disc drive. The drives and their associated computer readable media provide non-volatile storage of computer-executable instructions, data structures, program modules, and other data for the system 500. Software applications may be stored on the primary and secondary storage means 511, 512 as well as the system memory 502.

The computing system 500 may operate in a networked environment using logical connections to one or more remote computers via a network adapter 516.

Input/output devices 513 may be coupled to the system either directly or through intervening I/O controllers. A user may enter commands and information into the system 500 through input devices, such as a keyboard, pointing device, or other input devices (for example, microphone, joy stick, game pad, satellite dish, scanner, or the like). Output devices may include speakers, printers, etc. A display device 514 is also connected to system bus 503 via an interface, such as video adapter 515.

Wasted processing may be prevented by grouping identical read requests, doing the processing once, and returning that result to the group with the same request. Many systems will use caching to try to reduce duplicate processing; however, some systems may not have enough space for a cache. Rather than using a cache, this method analyses the request queue to determine if any requests can be processed together as if they were a single request.

This solution suits a system with many requests in a queue where the system does not have the resources available to create a cache. For example, if the requests produce very large responses. The solution is aimed at systems where many of the requests are read operations.

An example of a system where this method would be preferable to using an existing solution is a library of large documents that many people access concurrently. A cache may only be able to hold a few documents at once, while the requests may be for more documents than the cache could hold. If the system groups requests for the same document it will only need to go and read that file once for all of the requests.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Improvements and modifications can be made to the foregoing without departing from the scope of the present invention.

What is claimed is:

1. A method for managing queued requests, the method comprising:
accessing, by one or more processors, a queue that includes a plurality of read requests;
identifying, by one or more processors, read requests in the plurality of read requests that are identical; and
determining, by one or more processors, whether grouping the identical read requests is an efficient use of one or more resources.

2. The method of claim 1, further comprising:
responsive to determining that grouping the identical read requests is an efficient use of one or more resources, grouping, by one or more processors, the identical read requests together for processing as a single request.

3. The method of claim 1, wherein the determining whether grouping the identical read requests is an efficient use of one or more resources occurs at runtime.

4. The method of claim 1, further comprising:
determining, by one or more processors, whether the identified identical read requests include any intervening write requests that separate one or more of the identified identical read requests; and
responsive to determining that the identified identical read requests do include intervening write requests, determining, by one or more processors, whether the intervening write requests affect the identified identical read requests.

5. The method of claim 1, wherein determining whether grouping the identical read requests is an efficient use of one or more resources, further comprises:
selecting, by one or more processors, a resource;
determining, by one or more processors, an average request response usage of the resource;
determining, by one or more processors, an average queue grouping processing usage of the response per request; and
determining, by one or more processors, whether the determined average request response usage of the resource is greater than the determined average queue grouping processing usage of the response per request.

6. The method of claim 5, wherein the one or more resources include time, memory usage, processing usage, network usage, disk usage, database usage.

7. The method of claim 1, further comprising:
determining, by one or more processors, whether the accessed queue includes a read request that is more general than the identified identical read requests, wherein a more general read request includes information requested in a less general read request; and
responsive to determining that the accessed queue does include a read request that is more general than the identified identical read requests, grouping, by one or more processors, the identified identical read requests after the more general read request.

8. A computer program product for managing queued requests, the computer program product comprising:
one or more computer readable storage media and program instructions stored on the one or more computer readable storage media, the program instructions comprising:
program instructions to access a queue that includes a plurality of read requests;
program instructions to identify read requests in the plurality of read requests that are identical; and
program instructions to determine whether grouping the identical read requests is an efficient use of one or more resources.

9. The computer program product of claim 8, further comprising program instructions, stored on the one or more computer readable storage media, to:
responsive to determining that grouping the identical read requests is an efficient use of one or more resources, group the identical read requests together for processing as a single request.

10. The computer program product of claim 8, wherein the determining whether grouping the identical read requests is an efficient use of one or more resources occurs at runtime.

11. The computer program product of claim 8, further comprising program instructions, stored on the one or more computer readable storage media, to:
determine whether the identified identical read requests include any intervening write requests that separate one or more of the identified identical read requests; and
responsive to determining that the identified identical read requests do include intervening write requests, determine whether the intervening write requests affect the identified identical read requests.

12. The computer program product of claim 1, wherein the program instructions to determine whether grouping the identical read requests is an efficient use of one or more resources, further comprise program instructions to:
select a resource;
determine an average request response usage of the resource;
determine an average queue grouping processing usage of the response per request; and
determine whether the determined average request response usage of the resource is greater than the determined average queue grouping processing usage of the response per request.

13. The computer program product of claim 12, wherein the one or more resources include time, memory usage, processing usage, network usage, disk usage, database usage.

14. The computer program product of claim 8, further comprising program instructions, stored on the one or more computer readable storage media, to:
determine whether the accessed queue includes a read request that is more general than the identified identical read requests, wherein a more general read request includes information requested in a less general read request; and
responsive to determining that the accessed queue does include a read request that is more general than the identified identical read requests, group the identified identical read requests after the more general read request.

15. A computer system for managing queued requests, the computer system comprising:
one or more computer processors;
one or more computer readable storage media; and
program instructions stored on the computer readable storage media for execution by at least one of the one or more processors, the program instructions comprising:
program instructions to access a queue that includes a plurality of read requests;
program instructions to identify read requests in the plurality of read requests that are identical; and
program instructions to determine whether grouping the identical read requests is an efficient use of one or more resources.

16. The computer system of claim 15, further comprising program instructions, stored on the computer readable storage media for execution by at least one of the one or more processors, to:
responsive to determining that grouping the identical read requests is an efficient use of one or more resources, group the identical read requests together for processing as a single request.

17. The computer system of claim 15, wherein the determining whether grouping the identical read requests is an efficient use of one or more resources occurs at runtime.

18. The computer system of claim 15, further comprising program instructions, stored on the computer readable storage media for execution by at least one of the one or more processors, to:
determine whether the identified identical read requests include any intervening write requests that separate one or more of the identified identical read requests; and
responsive to determining that the identified identical read requests do include intervening write requests, determine whether the intervening write requests affect the identified identical read requests.

19. The computer system of claim 15, wherein the program instructions to determine whether grouping the identical read requests is an efficient use of one or more resources, further comprise program instructions to:
select a resource;
determine an average request response usage of the resource;
determine an average queue grouping processing usage of the response per request; and
determine whether the determined average request response usage of the resource is greater than the determined average queue grouping processing usage of the response per request.

20. The computer system of claim 15, further comprising program instructions, stored on the computer readable storage media for execution by at least one of the one or more processors, to:
determine whether the accessed queue includes a read request that is more general than the identified identical read requests, wherein a more general read request includes information requested in a less general read request; and
responsive to determining that the accessed queue does include a read request that is more general than the identified identical read requests, group the identified identical read requests after the more general read request.
